(19) United States
(12) Patent Application Publication
(10) Pub. No.: US 2026/0145658 A1
(43) Pub. Date: May 28, 2026

(54) ELECTRIC BRAKING DEVICE

(71) Applicant: ADVICS CO., LTD., Kariya-shi, Aichi-ken (JP)

(72) Inventors: Satoshi HIRATA, Kariya-shi, Aichi-ken (JP); Naru SUGIMOTO, Kariya-shi, Aichi-ken (JP)

(73) Assignee: ADVICS CO., LTD., Kariya-shi, Aichi-ken (JP)

(21) Appl. No.: 19/120,307

(22) PCT Filed: Oct. 11, 2023
(86) PCT No.: PCT/JP2023/036840

§ 371 Date: Apr. 11, 2025

(30) Foreign Application Priority Data
Oct. 13, 2022 (JP) 2022-165031

(51) Int. Cl. B60T 13/74; F16D 65/18; F16D 66/00; F16D 121/24; F16D 125/40; F16D 125/48; F16D 127/02

(52) U.S. Cl. CPC B60T 13/746; F16D 65/18; F16D 66/00; F16D 2066/005; F16D 2121/24; F16D 2125/40; F16D 2125/48; F16D 2127/02

(57) ABSTRACT

An urging member configured to urge a rotation part from a linear motion part side toward a transmission mechanism side is disposed between the linear motion part and the transmission mechanism in a rotational axis direction of the rotation part, and the urging member includes a first engaging part engaged with the rotation part and a second engaging part engaged with the housing on the transmission mechanism side than the first engaging part.

### TECHNICAL FIELD

The present disclosure relates to an electric braking device.

### BACKGROUND ART

Patent Literature 1 discloses a prior art of an electric disk brake, and a configuration of the electric disk brake according to the prior art will be briefly described as follows.

An outer side case that accommodates a brim portion of a rotating body (referred to as a drive spindle in Patent Literature 1) in a linear motion conversion mechanism (referred to as a thrust generation mechanism in Patent Literature 1) is provided on the far side of the cylindrical cylinder portion of the caliper. An elastic member that urges the rotating body toward the opposite side (the other side in the axial direction) of a claw portion of the caliper is provided between the inner wall surface of the outer side case and the brim portion of the rotating body. The elastic member is pressure welded to the brim portion of the rotating body from one side in the axial direction by its elastic force. As a result, the rotating body is held immovably in the axial direction with respect to the caliper by the urging force of the elastic member, and displacement of the rotating body in the axial direction due to vibration from the wheel is suppressed, so that vibration resistance of the linear motion conversion mechanism can be improved.

### CITATIONS LIST

### Patent Literature Patent Literature 1: Japanese Patent Application Laid-Open No. 2010-265971

### SUMMARY

### Technical Problems

In Patent Literature 1, the elastic member urges the brim portion of the rotating body from the friction member side to the transmission mechanism side, but the elastic member is supported by the outer side case having a bottom surface provided on the friction member side. As a result, since the bottom surface of the outer side case that supports the elastic member needs to be disposed on the linear motion conversion mechanism side, the degree of freedom in the arrangement of the linear motion conversion mechanism is reduced.

Therefore, an object of one aspect of the present disclosure is to improve vibration resistance while increasing the degree of freedom of arrangement of the linear motion conversion mechanism.

### Solutions to Problems

In order to solve the above-described problem, an electric braking device according to one aspect of the present disclosure is an electric braking device in which a rotation of an electric motor is transmitted to a linear motion conversion mechanism by a transmission mechanism, a rotary motion transmitted by the transmission mechanism is converted into a linear motion of a linear motion part from a rotary motion of a rotation part in the linear motion conversion mechanism, and a friction member interlocked with the linear motion of the linear motion part is pressed against a rotating body rotating together with a wheel to generate a braking force on the wheel, the electric braking device including, a housing configured to store the linear motion conversion mechanism disposed between the friction member and the transmission mechanism in a rotational axis direction of the rotation part, and an urging member disposed between the linear motion part and the transmission mechanism in the rotational axis direction, and configured to have a first engaging part engaged with the rotation part and a second engaging part engaged with the housing on the transmission mechanism side than the first engaging part, and urge the rotation part from the linear motion part side toward the transmission mechanism side.

### Advantageous Effects

According to one aspect of the present disclosure, vibration resistance can be improved while increasing the degree of freedom of arrangement of the linear motion conversion mechanism.

### BRIEF DESCRIPTION OF DRAWINGS

FIG. 1 is a schematic cross-sectional view of an electric disk brake according to an embodiment of the present disclosure.

FIG. 2 is an enlarged cross-sectional view of a main part of the electric disk brake illustrated in FIG. 1.

FIG. 3 is an enlarged cross-sectional view taken along line III-III in FIG. 2.

FIG. 4 is an enlarged cross-sectional view of IV in FIG. 2.

FIG. 5 is an enlarged cross-sectional view for explaining another engagement mode between a peripheral edge portion of a through-hole of a leaf spring and a spindle.

FIG. 6 is an enlarged cross-sectional view for explaining another engagement mode between the peripheral edge portion of the through-hole of the leaf spring and the spindle.

### DESCRIPTION OF EMBODIMENTS

Hereinafter, an embodiment of the present disclosure will be described with reference to the drawings. Note that in the specification and claims, the rotational axis direction refers to the rotational axis direction of a rotation part. One side in the rotational axis direction refers to a direction toward the outer side of the vehicle in the rotational axis direction. The other side in the rotational axis direction refers to a direction toward the inner side of the vehicle in the axial direction. In the drawings, “AD” indicates a rotational axis direction, “ADO” indicates one side in the rotational axis direction, and “ADi” indicates the other side in the rotational axis direction.

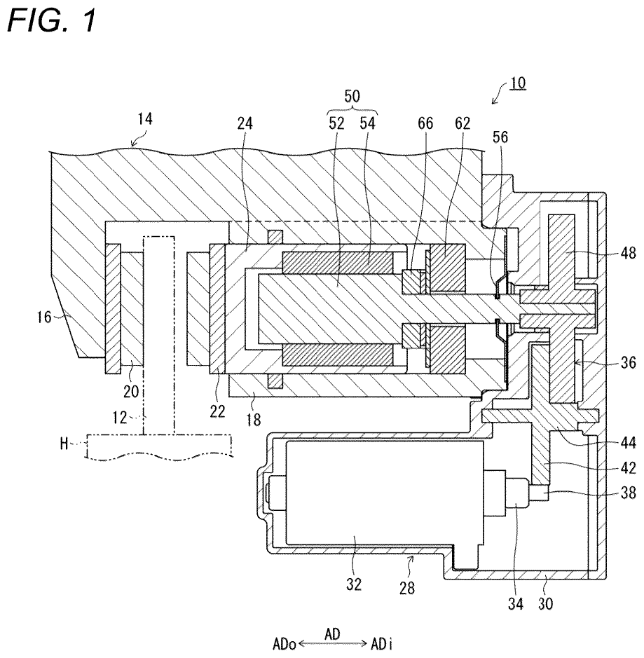

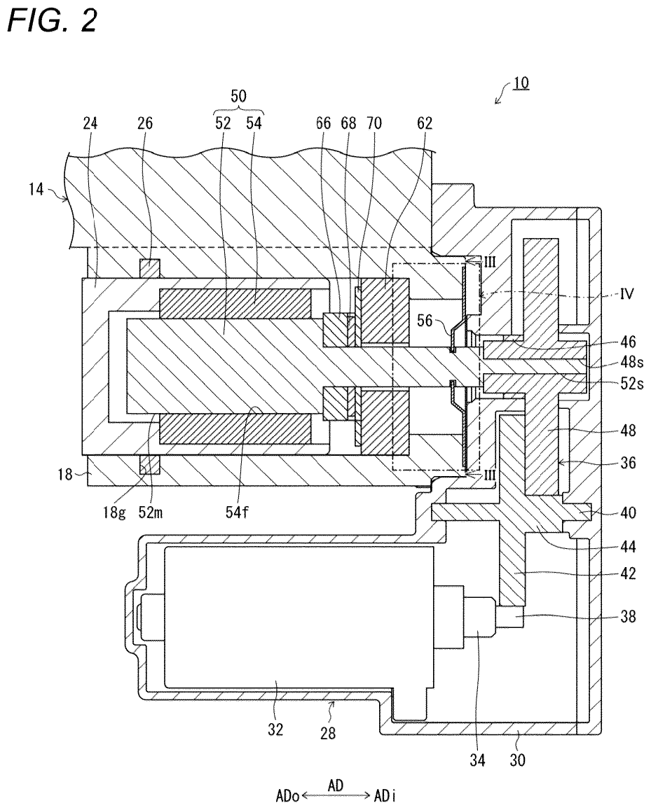

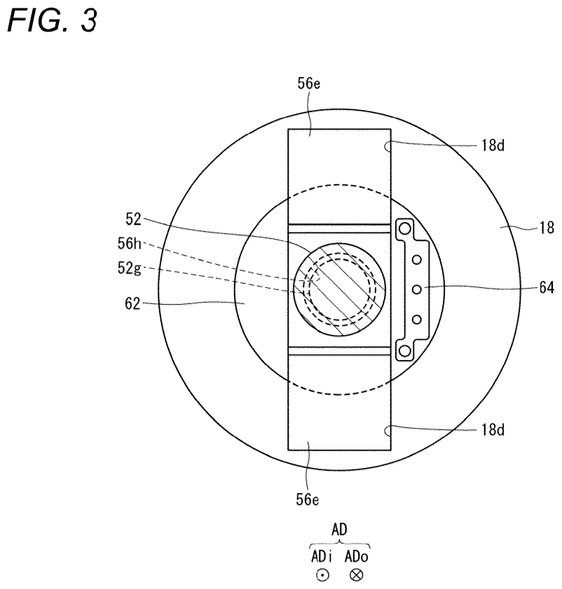

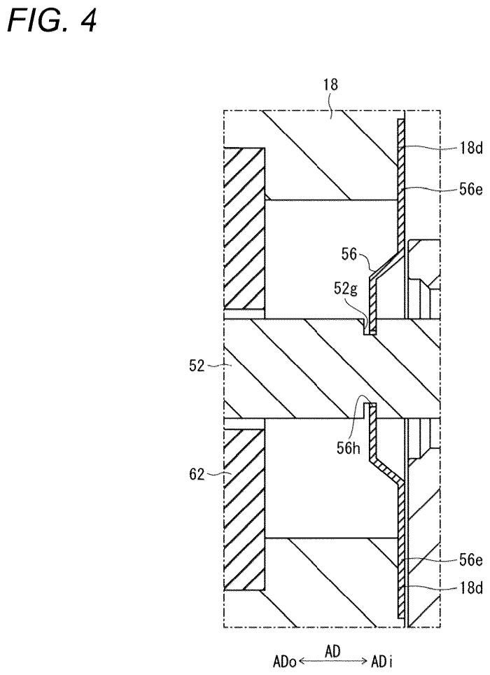

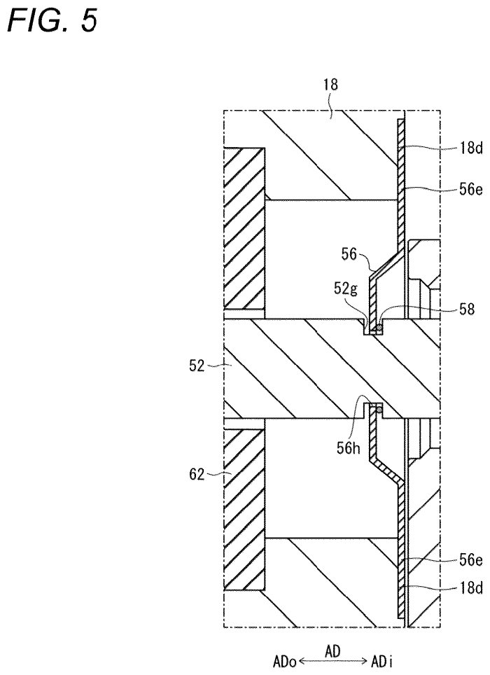

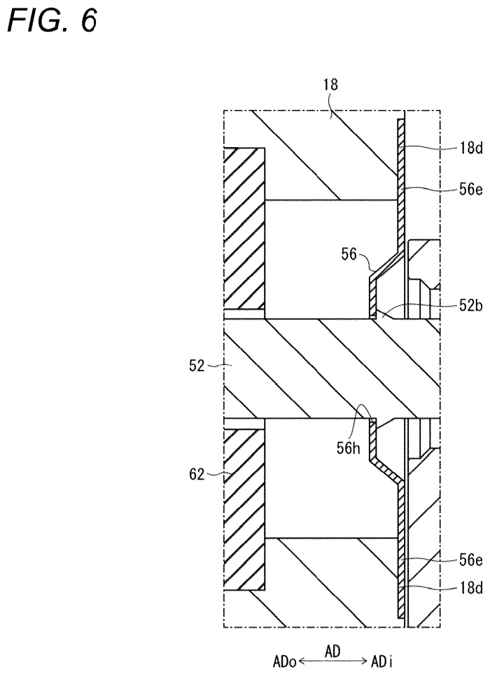

An embodiment of the present disclosure will be described with reference to FIGS. 1 through 6. FIG. 1 is a schematic cross-sectional view of an electric disk brake according to an embodiment of the present disclosure. FIG. 2 is an enlarged cross-sectional view of a main part of the electric disk brake illustrated in FIG. 1. FIG. 3 is an enlarged cross-sectional view taken along line III-III in FIG. 2. FIG. 4 is an enlarged cross-sectional view of IV in FIG. 2. FIGS. 5 and 6 are enlarged cross-sectional views for explaining another engagement mode between a peripheral edge portion of a through-hole of a leaf spring and a spindle.

### Electric Braking Device 10, Caliper Housing 14

As illustrated in FIG. 1, an electric braking device 10 according to the embodiment is an electric disk brake configured to brake wheels of a vehicle. The electric braking device 10 includes a caliper housing 14 (corresponding to housing in the claims) provided so as to cross the peripheral edge portion of a rotating body 12 from both sides in the rotational axis direction of the rotating body 12. The rotating body 12 rotates integrally with a vehicle H.

### Claw Portion 16, Cylinder Portion 18

As illustrated in FIG. 1, the caliper housing 14 is movably supported in the rotational axis direction by a mount (not illustrated) serving as a non-rotating member provided in the vicinity of the rotating body 12. The caliper housing 14 has a claw portion 16 on one side in the rotational axis direction, which claw portion 16 protrudes out toward a direction orthogonal to the rotational axis direction. The caliper housing 14 has a cylindrical cylinder portion 18 on the other side in the rotational axis direction, which cylinder portion 18 is opened toward one side in the rotational axis direction.

### Outer Friction Member 20, Inner Friction Member 22

As illustrated in FIG. 1, the electric braking device 10 includes two friction members 20 and 22 arranged between the claw portion 16 of the caliper housing 14 and the cylinder portion 18, which two friction members 20 and 22 are supported on the mount to be movable in the rotational axis direction. Of the two friction members 20 and 22, the outer friction member 20 located on one side in the rotational axis direction presses one side surface of the rotating body 12. The outer friction member 20 is in sliding contact with one side surface of the rotating body 12 in a state of pressing the one side surface of the rotating body 12. Of the two friction members 20 and 22, the inner friction member 22 located on the other side in the rotational axis direction presses the other side surface of the rotating body 12. The inner friction member 22 is in sliding contact with the other side surface of the rotating body 12 in a state of pressing the other side surface of the rotating body 12.

### Piston 24

As illustrated in FIGS. 1 and 2, a bottomed cylindrical piston 24 that presses the inner friction member 22 toward the claw portion side (one side in the rotational axis direction) is provided in the cylinder portion 18 of the caliper housing 14 to be movable in the rotational axis direction. The other side in the rotational axis direction of the piston 24 is opened. The piston 24 is configured to be non-rotatable with respect to the cylinder portion 18 of the caliper housing 14 by a fixed rotation lock bolt (not illustrated) of the cylinder portion 18 of the caliper housing 14. Furthermore, a peripheral groove 18g is formed on the inner peripheral surface of the cylinder portion 18. A piston seal 26 is provided by being fitted into a peripheral groove 18g of the cylinder portion 18, and the piston seal 26 is in sliding contact with the outer peripheral surface of the piston 24.

### Motor Gear Unit 28, Unit Case 30, Electric Motor 32, Transmission Mechanism 36

As illustrated in FIGS. 1 and 2, a motor gear unit 28 for driving the electric braking device 10 is provided on a side portion of the cylinder portion 18 of the caliper housing 14. The motor gear unit 28 includes a unit case 30 provided on a side portion of the cylinder portion 18 of the caliper housing 14, an electric motor 32 provided in the unit case 30, and a transmission mechanism 36 connected to an output shaft 34 of the electric motor 32 and configured to increase a rotational torque of the electric motor.

### Main Driving Gear 38, Intermediate Large Gear 42, Intermediate Small Gear 44, and Driven Gear 48

As illustrated in FIG. 2, the transmission mechanism 36 includes a main driving gear 38 provided integrally with the output shaft 34 of the electric motor 32, and an intermediate large gear 42 rotatably provided in the unit case 30 via a gear shaft 40. The intermediate large gear 42 meshes with the main driving gear 38, and the outer diameter of the intermediate large gear 42 is larger than the outer diameter of the main driving gear 38. The transmission mechanism 36 includes an intermediate small gear 44 integrally provided coaxially with the intermediate large gear 42, and a driven gear 48 rotatably provided in the unit case 30 via a radial bearing 46. The outer diameter of the intermediate small gear 44 is smaller than the outer diameter of the intermediate large gear 42. The driven gear 48 meshes with the intermediate small gear 44, and the outer diameter of the driven gear 48 is larger than the outer diameter of the intermediate small gear 44. A female spline portion 48s is formed at a central portion of the driven gear 48.

### Linear Motion Conversion Mechanism 50, Rotation Part 52

As illustrated in FIG. 2, a linear motion conversion mechanism 50 configured to convert rotary motion transmitted from the transmission mechanism 36 into a linear motion is provided in the cylinder portion 18 of the caliper housing 14. In other words, the cylindrical cylinder portion 18 that stores the linear motion conversion mechanism 50 is disposed between the inner friction member 22 and the transmission mechanism 36 in the rotational axis direction. The linear motion conversion mechanism 50 includes a rotation part 52 that rotates by the rotary motion transmitted from the transmission mechanism 36. The rotation part 52 extends in the rotational axis direction, and a male spline portion 52s to be spline-fitted to the female spline portion 48s of the driven gear 48 is formed at a site on the other side in the rotational axis direction on the outer peripheral surface of the rotation part 52. When the male spline portion 52s of the rotation part 52 and the female spline portion 48s of the driven gear 48 are spline-fitted, the rotation part 52 is connected to the driven gear 48. A male screw portion 52m is formed at a site on one side in the rotational axis direction on the outer peripheral surface of the rotation part 52, and an outer diameter of the male screw portion 52m is larger than an outer diameter of the male spline portion 52s. A peripheral groove serving as a concave portion extending in the peripheral direction is formed in the vicinity of the male spline portion 52s in the outer peripheral portion of the rotating shaft portion (a site between the male screw portion 52m and the male spline portion 52s) having a cylindrical shape concentric with the shaft center of the rotation part 52.

### Linear Motion Part 54

As illustrated in FIG. 2, the linear motion conversion mechanism 50 includes a linear motion part 54 that linearly moves in the rotational axis direction in conjunction with the rotation of the rotation part 52. The linear motion part 54 is provided by being screw-fitted to the male screw portion 52m of the rotation part 52, and is located on an inner side of the piston 24. The linear motion part 54 is formed with a female screw portion 54f to be screw-fitted to the male screw portion 52m of the rotation part 52.

### Leaf Spring 56

As illustrated in FIGS. 2 through 4, a band-shaped leaf spring 56 serving as an urging member configured to urge the rotation part 52 from the linear motion part 54 side toward the transmission mechanism 36 side is disposed at the end portion on the other side in the rotational axis direction in the cylinder portion 18 of the caliper housing 14. In other words, the band-shaped leaf spring 56 is disposed between the linear motion part 54 and the transmission mechanism 36 in the rotational axis direction. The leaf spring 56 applies pressure to the rotation part 52 by urging the rotation part 52 toward the transmission mechanism 36 side. Furthermore, a through-hole 56h through which the rotation part 52 is inserted is formed in the intermediate portion of the leaf spring 56, and the inner diameter of which through-hole 56h is smaller than the outer diameter of the male spline portion 52s of the rotation part 52 and of the vicinity thereof. Note that a shape of the leaf spring 56 is not limited to a band shape.

A peripheral edge portion of the through-hole 56h of the leaf spring 56 is a first engaging part engaged with the 52g of the rotation part 52. The peripheral edge portion of the through-hole 56 of the leaf spring 56 is relatively rotatable and immovable with respect to the 52g of the rotation part 52. Both end portions 56e of the leaf spring 56 are second engaging parts engaged with the cylinder portion 18 on the transmission mechanism 36 side than both end portions 56e of the leaf spring 56 serving as the first engaging part. The leaf spring 56 is bent-molded such that an intermediate portion of the leaf spring 56 protrudes out to one side in the rotational axis direction. In other words, the leaf spring 56 is bent-molded such that both end portions 56e of the leaf spring 56 are located on the transmission mechanism 36 side than the peripheral edge portion of the through-hole 56h of the leaf spring 56. The peripheral edge portion of the through-hole 56h of the leaf spring 56 may be indirectly engaged by way of another member instead of being directly engaged with the peripheral groove 52g of the rotation part 52.

At the end portion on the other side in the rotational axis direction of the cylinder portion 18, two concave portions 18d to be respectively engaged with both end portions 56e of the leaf spring 56 are formed to be recessed to one side in the rotational axis direction. In other words, the engagement between the both end portions 56e of the leaf spring 56 and the two concave portions 18d of the cylinder portion 18 prevent the both end portions 56e of the leaf spring 56, which are the first engaging part, from rotating with respect to the cylinder portion 18. Furthermore, the both end portions 56e of the leaf spring 56 are sandwiched between the cylinder portion 18 of the caliper housing 14 and the unit case 30 in a state of being engaged with the two concave portions 18d of the cylinder portion 18.

As illustrated in FIG. 5, a peripheral edge portion of the through-hole 56h of the leaf spring 56 may be engaged with the peripheral groove 52g of the rotation part 52 by way of a plurality of balls 58 serving as sliding members. In this case, the plurality of balls 58 are configured not to be separated from the inside of the peripheral groove 52g of the rotation part 52. Note that the sliding member is not limited to the ball 58, and may be any member that improves lubrication, such as grease.

Instead of the peripheral groove 52g, an annular protruding portion 52b may be formed as a convex portion extending in the peripheral direction on the outer peripheral portion of the rotating shaft portion of the rotation part 52 as illustrated in FIG. 6. The peripheral edge portion of the through-hole 56h of the leaf spring 56 may be engaged with the protruding portion 52b of the rotation part 52. In this case, the inner diameter of the through-hole 56h of the leaf spring 56 is smaller than the outer diameter of the protruding portion 52b of the rotation part 52. Instead of forming the annular protruding portion 52b in the vicinity of the male spline portion 52s in the rotation part 52, a plurality of protruding portions may be formed at intervals in the peripheral direction.

### Load Sensor 62, Transmission Member 66

As illustrated in FIGS. 1 and 2, a load sensor 62 configured to detect a pressing load of the inner friction member 22, which is a friction member with respect to the rotating body 12, is provided on the far side in the cylinder portion 18 of the caliper housing 14. In other words, the load sensor 62 is provided between the linear motion part 54 and the leaf spring 56 in the rotational axis direction. Furthermore, as illustrated in FIG. 3, a sensor connecting portion 64 of the load sensor 62 is located at a position away from the leaf spring 56 when viewed from the far side of the cylinder portion 18 of the caliper housing 14. Note that even when the shape of the leaf spring 56 is a shape different from the band shape, the sensor connecting portion 64 is located at a position away from the leaf spring 56 when viewed from the far side of the cylinder portion 18 of the caliper housing 14.

As illustrated in FIGS. 1 and 2, an annular transmission member 66 configured to transmit a force in the rotational axis direction from the rotation part 52 corresponding to (equivalent to) the pressing load of the inner friction member 22 to the load sensor 62 is provided between the intermediate portion of the rotation part 52 and the load sensor 62 by way of a thrust bearing 68 and a washer 70. In other words, the annular transmission member 66 is provided between the linear motion part 54 and the load sensor 62 in the rotational axis direction.

### Operation of Electric Braking Device 10

Next, the operation of the electric braking device 10 will be described.

As illustrated in FIG. 1, for example, when a driver depression-operates a brake pedal (not illustrated), the rotation part 52 is rotated in the forward direction by the driving of the electric motor 32 in a state where the rotational torque of the electric motor 32 is increased by the transmission mechanism 36. Then, the linear motion part 54 moves toward the claw portion 16 side of the caliper housing 14 (one side in the rotational axis direction) by the screw-fitting action of the male screw portion 52m and the female screw portion 54f, and the piston 24 also moves toward the claw portion 16 side of the caliper housing 14 integrally with the linear motion part 54. As a result, the piston 24 abuts on the inner friction member 22, and the inner friction member 22 can be pressed toward the claw portion 16 side of the caliper housing 14. Furthermore, when the piston 24 abuts on the inner friction member 22, the outer friction member 20 abuts on the rotating body 12 as the caliper housing 14 moves by the slide pin of the caliper housing 14 (not illustrated) due to the reaction force received from the rotating body 12.

As a result, the two friction members 20 and 22, which are friction members, can be pressed so as to sandwich the rotating body 12 to generate a braking force on the wheels of the vehicle.

### Operations and Effects

Next, operations and effects of the embodiment of the present disclosure will be described.

In the electric braking device 10, as described above, the leaf spring 56 that urges the rotation part 52 toward the transmission mechanism 36 side (the other side in the rotational axis direction) is disposed between the linear motion part 54 and the transmission mechanism 36 in the rotational axis direction. The both end portions 56e of the leaf spring 56, which are the second engaging part engaged with the cylinder portion 18, are disposed on the transmission mechanism 36 side than the peripheral edge portion of the through-hole 56h of the leaf spring 56, which is the first engaging part engaged with the rotation part 52 in the rotational axis direction, so that the leaf spring 56, which is the urging member, urges the rotation part 52 from the linear motion part 54 side toward the transmission mechanism 36 side. As a result, the both end portions 56e of the leaf spring 56 do not interfere with the linear motion part 54, and hence the vibration resistance of the linear motion conversion mechanism 50 can be improved by suppressing the displacement of the rotation part 52 in the axial direction due to the vibration (impact) from the wheel while increasing the degree of freedom in arrangement of the linear motion conversion mechanism 50.

In particular, when the peripheral edge portion of the through-hole 56h of the leaf spring 56 is relatively rotatably engaged with the peripheral groove 52g of the rotation part 52 via a sliding member such as a plurality of balls 58, the rotary motion of the rotation part 52 is less likely to be inhibited by the leaf spring 56. As a result, the operation efficiency of the electric braking device 10 can be enhanced by further suppressing an increase in the lost torque.

Furthermore, in the electric braking device 10, the load sensor 62 is provided between the linear motion part 54 and the leaf spring 56 in the rotational axis direction, and the transmission member 66 is provided between the linear motion part 54 and the load sensor 62 in the rotational axis direction. As the force in the rotational axis direction from the rotation part 52 corresponding to the pressing load is transmitted to the load sensor 62 by the transmission member 66, when the leaf spring 56 urges the rotation part 52 toward the transmission mechanism 36 side, the load sensor 62 is urged toward the transmission mechanism 36 side via the transmission member 66. As a result, according to the embodiment of the present disclosure, the displacement of the load sensor 62 in the axial direction due to the vibration from the wheels can be suppressed, and effects of suppressing the decrease in the detection accuracy of the load sensor 62 and preventing the damage of the load sensor 62 can be obtained. In addition, since the transmission member 66 is configured separately from the rotation part 52, there is no portion that protrudes out from the rotation part 52 in the radial direction of the rotation part 53, and thus the rotation part 52 can be molded by rolling, and the rotation part 52 can be manufactured at low cost.

Furthermore, in the electric braking device 10, the both end portions 56e of the leaf spring 56, which are the second engaging part of the urging member, are prevented from rotating with respect to the cylinder portion 18. That is, since the leaf spring 56 is prevented from co-rotating by the rotary motion of the rotation part 52, this contributes to suppression of generation of foreign substances due to sliding and wear of the both end portions 56e of the leaf spring 56 and improvement of durability of the leaf spring 56 itself.

Furthermore, by engaging the both end portions 56e of the leaf spring 56 formed in a band shape with the two concave portions 18d of the cylinder portion 18, the prevention of rotation of the leaf spring 56 can be realized with a simple structure. Here, a convex portion may be provided in the cylinder portion 18 instead of the concave portion 18d, and the prevention of rotation may be realized by engagement between the convex portion and the both end portions 56e of the leaf spring 56.

Furthermore, by engaging the band-shaped leaf spring 56 with the cylindrical cylinder portion 18, a space can be provided between the cylinder portion 18 and the leaf spring 56 in the radial direction of the rotation part 52. As a result, the components of the electric braking device 10, for example, the sensor connecting portion 64 can be disposed, which contributes to miniaturization of the electric braking device 10.

The rotation part 52 includes a rotating shaft portion having a cylindrical shape concentric with the shaft center thereof, where a concave portion (peripheral groove 52g) or a convex portion (protruding portion 52b) extending in the peripheral direction is formed in an outer peripheral portion of the rotating shaft portion of the rotation part 52, and the urging member is configured as a leaf spring 56 in which a through-hole 52h through which the rotating shaft portion of the rotation part 52 is inserted is formed. With the peripheral edge portion of the through-hole 56h of the leaf spring 56 as the first engaging part, the rotating shaft portion of the rotation part 52 can be urged with a uniform force, and the durability of the linear motion conversion mechanism 50 can be improved as compared with a case where the rotating shaft portion of the rotation part 52 is urged with a biased force. In addition, since the leaf spring 56 and the rotation part 52 can be engaged only by the process of passing the rotation part 52 through the through-hole 56h of the leaf spring 56, the assembly property of the electric braking device 10 can be enhanced.

### Additional Remarks

The present disclosure is not limited to the above-described embodiments, and various modified examples can be made within the scope indicated in the Claims, and embodiments obtained by appropriately combining technical means disclosed in different embodiments are also included in the technical scope of the present disclosure. For example, in the present embodiment, the electric braking device 10 has been described as an example of an electric disk brake, but may be adapted to a drum brake. Furthermore, the present disclosure may be adapted to a configuration in which the linear motion part 54 rotates and the rotation part 52 linearly moves.

1. An electric braking device in which a rotation of an electric motor is transmitted to a linear motion conversion mechanism by a transmission mechanism, a rotary motion transmitted by the transmission mechanism is converted into a linear motion of a linear motion part from a rotary motion of a rotation part in the linear motion conversion mechanism, and a friction member interlocked with the linear motion of the linear motion part is pressed against a rotating body rotating together with a wheel to generate a braking force on the wheel, the electric braking device comprising:
a housing configured to store the linear motion conversion mechanism disposed between the friction member and the transmission mechanism in a rotational axis direction of the rotation part; and
an urging member disposed between the linear motion part and the transmission mechanism in the rotational axis direction, and configured to have a first engaging part engaged with the rotation part and a second engaging part engaged with the housing on the transmission mechanism side than the first engaging part, and urge the rotation part from the linear motion part side toward the transmission mechanism side.

2. The electric braking device according to claim 1, further comprising:
a load sensor provided between the linear motion part and the urging member in the rotational axis direction and configured to detect a pressing load of the friction member with respect to the rotating body; and
a transmission member provided between the linear motion part and the load sensor in the rotational axis direction and configured to transmit a force in the rotational axis direction from the rotation part corresponding to the pressing load to the load sensor.

3. The electric braking device according to claim 1, wherein the second engaging part is prevented from rotating with respect to the housing.

4. The electric braking device according to claim 3, wherein the urging member is a band-shaped leaf spring, and the housing engaged with the leaf spring has a cylindrical shape.

5. The electric braking device according to claim 1, wherein
the rotation part includes a rotating shaft portion having a cylindrical shape concentric with a shaft center thereof,
a concave portion or a convex portion extending in a peripheral direction is formed in an outer periphery portion of the rotating shaft portion,
the urging member is a leaf spring in which a through-hole into which the rotating shaft portion is inserted is formed, and
a peripheral edge portion of the through-hole of the leaf spring is the first engaging part.

6. The electric braking device according to claim 3, wherein
the urging member is a band-shaped leaf spring, and
the housing is formed with a concave portion or a convex portion engaged with each of both end portions of the leaf spring to regulate co-rotation of the leaf spring with the rotation part.

7. The electric braking device according to claim 2, wherein the urging member is a band-shaped leaf spring, and the housing engaged with the leaf spring has a cylindrical shape.

8. The electric braking device according to claim 1, wherein the urging member is a band-shaped leaf spring, and the housing engaged with the leaf spring has a cylindrical shape.
